(19) United States
(12) Patent Application Publication
(10) Pub. No.: US 2024/0393264 A1
(43) Pub. Date: Nov. 28, 2024

(54) WATER VAPOR OBSERVATION METHOD

(71) Applicant: NEC Corporation, Tokyo (JP)

(72) Inventor: Michihiko YUSA, Tokyo (JP)

(73) Assignee: NEC Corporation, Tokyo (JP)

(21) Appl. No.: 18/657,969

(22) Filed: May 8, 2024

(30) Foreign Application Priority Data
May 24, 2023 (JP) 2023-085362

(51) Int. Cl. G01N 22/04; G01S 19/14; G01W 1/10

(52) U.S. Cl. CPC G01N 22/04; G01S 19/14; G01W 1/10

(57) ABSTRACT

A water vapor observation apparatus includes: a determining unit that determines whether or not to use a GNSS (Global Navigation Satellite System) signal received by a receiving apparatus mounted on a mobile object and receiving the GNSS signal for estimation of precipitable water in accordance with a positional relation between the receiving apparatus and a GNSS satellite transmitting the GNSS signal at time of reception of the GNSS signal by the receiving apparatus; and an estimating unit that estimates precipitable water representing a water vapor content in atmosphere based on the GNSS signal received by the receiving apparatus or discards the estimated precipitable water in accordance with a result of the determining.

### INCORPORATION BY REFERENCE

This application is based upon and claims the benefit of priority from Japanese patent application No. 2023-085362, filed on May 24, 2023, the disclosure of which is incorporated herein in its entirety by reference.

### TECHNICAL FIELD

The present invention relates to a water vapor observation method, a water vapor observation apparatus, and a recording medium.

### BACKGROUND ART

Estimating a water vapor content in the atmosphere is performed as a method for weather observation. For example, there is a known technique of, when receiving on the ground a GNSS (Global Navigation Satellite System) signal transmitted from a GNSS satellite, measuring the delay time of the GNSS signal due to water vapor in the atmosphere and estimating a water vapor content in the atmosphere at the reception point as described in Patent Literature 1. This enables prediction of rainfall at each point, especially, prediction of torrential rain caused by sudden outbreak of a cumulonimbus cloud.
Patent Literature 1: Japanese Unexamined Patent Application Publication No. JP-A 2012-198645

However, places to install receiving apparatuses that receive GNSS signals are limited and, in some places, the distance therebetween is 30 km. Then, a water vapor content at a point located between the receiving apparatuses needs to be estimated from values at the points where the receiving apparatuses are installed, but it has been difficult to accurately estimate a water vapor content at a point where it is not actually measured. Thus, there has been a problem that it may be difficult to accurately estimate a water vapor content.

### SUMMARY OF THE INVENTION

Accordingly, an object of the present invention is to provide a water vapor observation method, a water vapor observation apparatus and a program that can solve the abovementioned problem.

A water vapor observation method as an aspect of the present invention includes: determining whether or not to use a GNSS (Global Navigation Satellite System) signal received by a receiving apparatus mounted on a mobile object and receiving the GNSS signal for estimation of precipitable water in accordance with a positional relation between the receiving apparatus and a GNSS satellite transmitting the GNSS signal at time of reception of the GNSS signal by the receiving apparatus; and estimating precipitable water representing a water vapor content in atmosphere based on the GNSS signal received by the receiving apparatus or discarding the estimated precipitable water in accordance with a result of the determining.

Further, a water vapor observation apparatus as an aspect of the present invention includes: a determining unit that determines whether or not to use a GNSS (Global Navigation Satellite System) signal received by a receiving apparatus mounted on a mobile object and receiving the GNSS signal for estimation of precipitable water in accordance with a positional relation between the receiving apparatus and a GNSS satellite transmitting the GNSS signal at time of reception of the GNSS signal by the receiving apparatus; and an estimating unit that estimates precipitable water representing a water vapor content in atmosphere based on the GNSS signal received by the receiving apparatus or discards the estimated precipitable water in accordance with a result of the determining.

Further, a recording medium as an aspect of the present invention is a non-transitory computer-readable recording medium on which a program is recorded, and the program includes instructions for causing an information processing apparatus to realize processes to: determine whether or not to use a GNSS (Global Navigation Satellite System) signal received by a receiving apparatus for estimation of precipitable water in accordance with a positional relation between the receiving apparatus and a GNSS satellite at time of reception of the GNSS signal by the receiving apparatus, the receiving apparatus being mounted on a mobile object and receiving the GNSS signal, the GNSS satellite transmitting the GNSS signal; and estimate precipitable water representing a water vapor content in atmosphere based on the GNSS signal received by the receiving apparatus or discard the estimated precipitable water in accordance with a result of the determining.

With the configurations as described above, the abovementioned problem can be solved.

### BRIEF DESCRIPTION OF DRAWINGS

FIG. 1 is a view showing an example of the configuration of a water vapor observation system in a first example embodiment of the present disclosure;

FIG. 2 is a block diagram showing an example of the configuration of a water vapor observation apparatus disclosed in FIG. 1;

FIG. 3 is a view for explaining an example of calculation of a positional relation;

FIG. 4 is a view for explaining an example of collision determination;

FIG. 5 is a view for explaining the example of collision determination;

FIG. 6 is a flowchart showing an example of the operation of the water vapor observation apparatus;

FIG. 7 is a block diagram showing another example of the configuration of the water vapor observation apparatus;

FIG. 8 is a view showing an example of the hardware configuration of a water vapor observation apparatus in a second example embodiment of the present disclosure; and

FIG. 9 is a block diagram showing an example of the water vapor observation apparatus.

### EXAMPLE EMBODIMENT

### First Example Embodiment

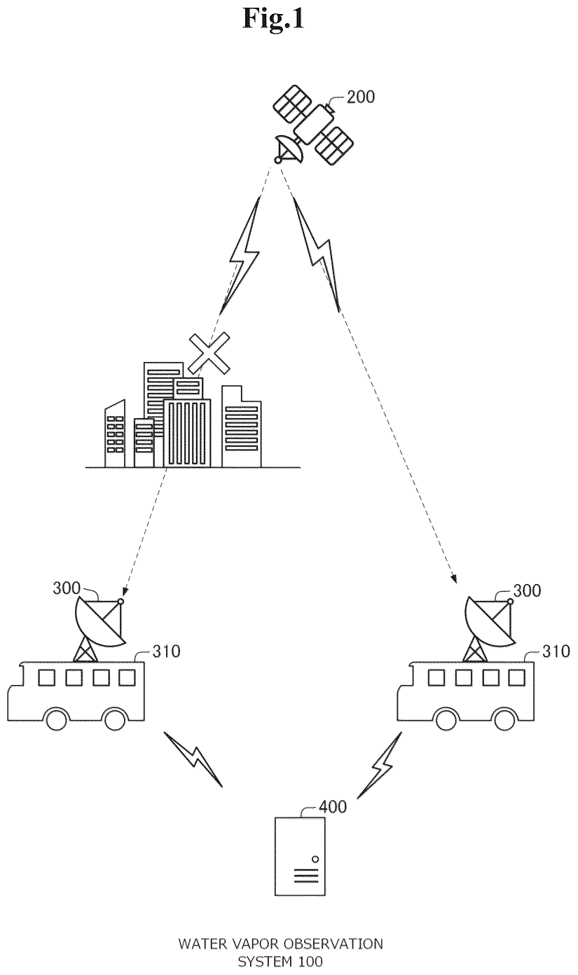

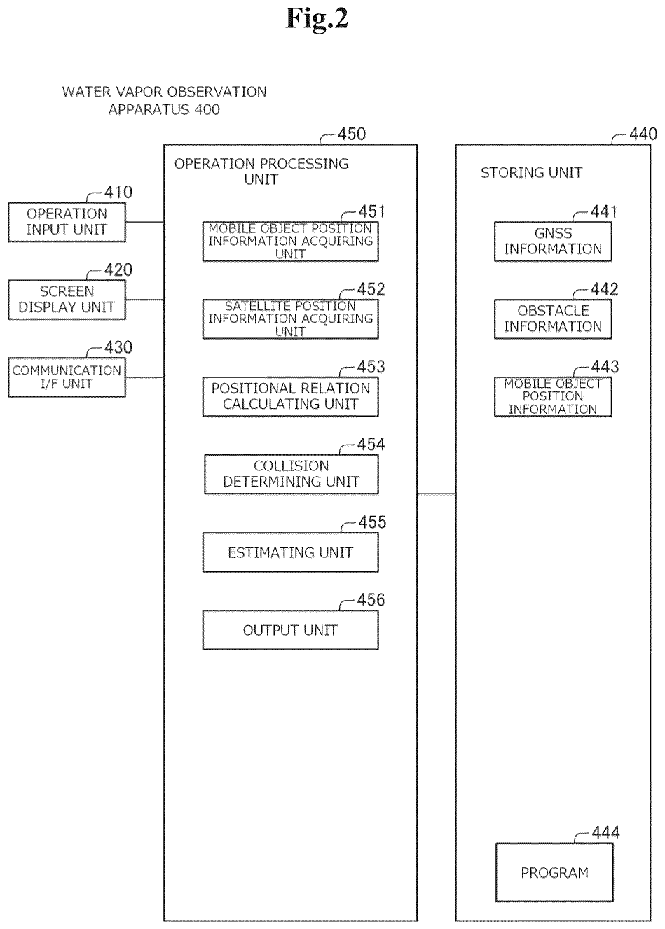

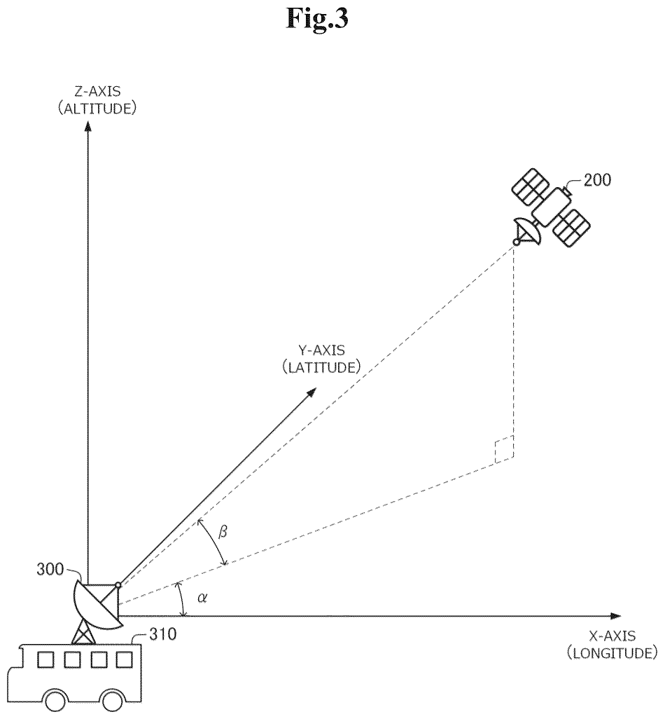

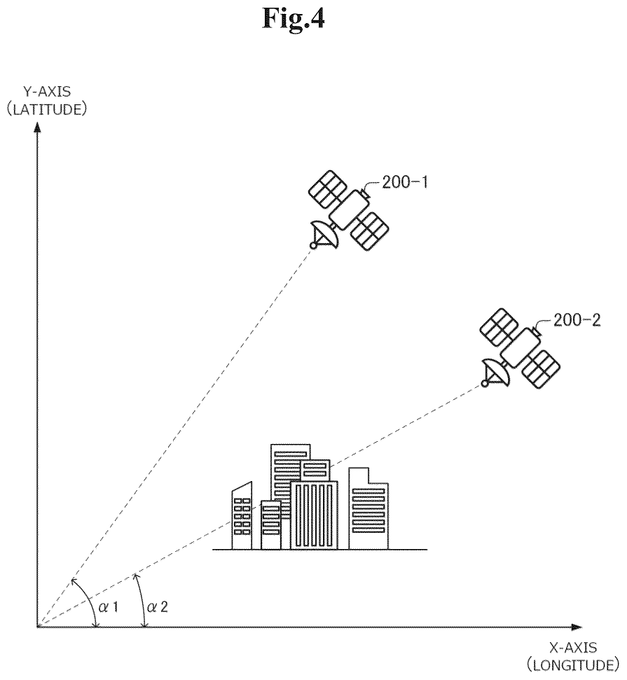

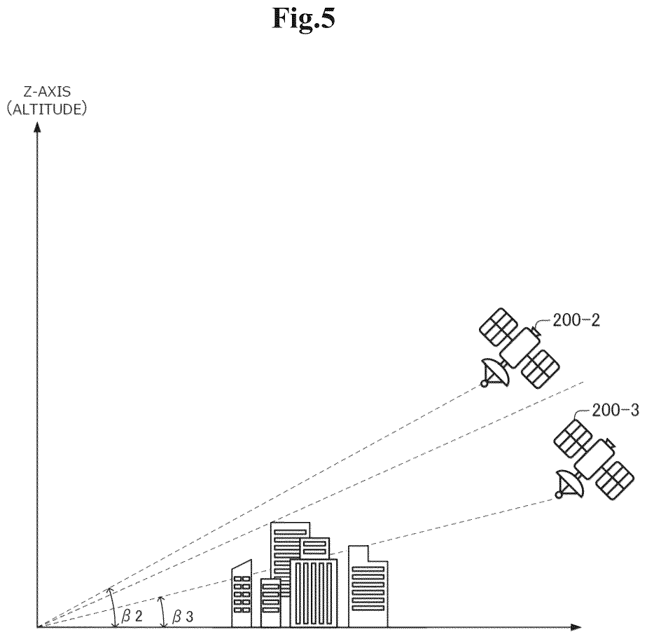

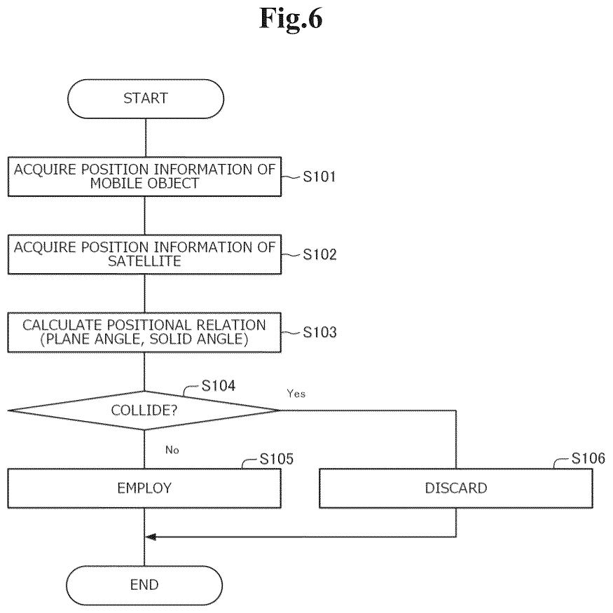

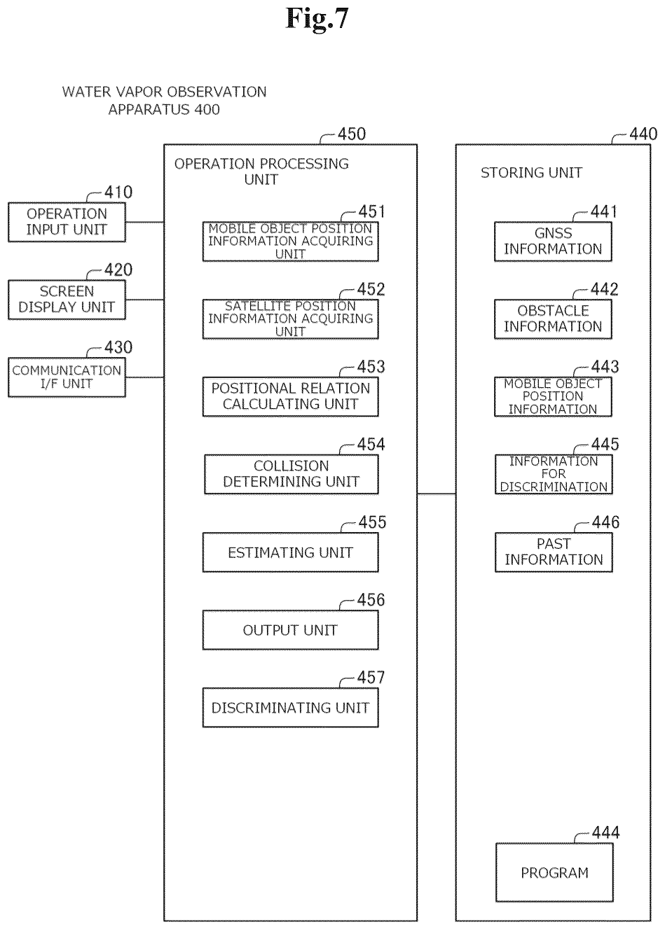

A first example embodiment of the present disclosure will be described with reference to FIGS. 1 to 7. FIG. 1 is a view showing an example of the configuration of a water vapor observation system 100. FIG. 2 is a block diagram showing an example of the configuration of a water vapor observation apparatus 400. FIG. 3 is a view for explaining an example of calculation of a positional relation. FIGS. 4 and 5 are views for explaining an example of collision determination. FIG. 6 is a flowchart showing an example of the operation of the water vapor observation apparatus 400. FIG. 7 is a block diagram showing another example of the configuration of the water vapor observation apparatus 400.

In the first embodiment of the present disclosure, the water vapor observation system 100 will be described that estimates precipitable water representing a water vapor content in the atmosphere based on a GNSS (Global Navigation Satellite System) signal transmitted from a GNSS satellite 200. As illustrated in FIG. 1, the water vapor observation system 100 includes a plurality of mobile objects 310 each equipped with a GNSS signal receiving apparatus 300 that receives a GNSS signal. For example, the water vapor observation system 100 receives a GNSS signal with each of the GNSS signal receiving apparatuses 300 mounted on the mobile objects 310. Then, the water vapor observation system 100 measures the delay time of the GNSS signal received by the GNSS signal receiving apparatus 300, and estimates precipitable water at a point where the GNSS signal receiving apparatus 300 has received the GNSS signal.

Further, the water vapor observation system 100 determines whether or not to use the received GNSS signal for estimation of precipitable water according to whether or not the positional relation between the GNSS satellite 200 and the GNSS signal receiving apparatus 300 satisfies a predetermined condition. For example, in a case where an obstacle such as a building is present between the GNSS satellite 200 and the GNSS signal receiving apparatus 300, the GNSS signal is reflected and it becomes difficult to accurately measure the delay time thereof. Thus, the water vapor observation system 100 checks whether or not an obstacle is present between the GNSS satellite 200 and the GNSS signal receiving apparatus 300 based on the positional relation between the GNSS satellite 200 and the GNSS signal receiving apparatus 300. Then, in a case where there is an obstacle, the water vapor observation system 100 determines not to use the received GNSS signal for estimation of precipitable water. On the other hand, in a case where there is no obstacle, the water vapor observation system 100 determines to use the received GNSS signal for estimation of precipitable water. For example, as described above, the water vapor observation system 100 can make different determinations according to whether or not an obstacle is present between the GNSS satellite 200 and the GNSS signal receiving apparatus 300. Meanwhile, the water vapor observation system 100 may estimate precipitable water according to the result of the above determination, or may discard estimated precipitable water according to the result of the above determination. In other words, the above determination may be performed before the process of estimating precipitable water, or may be performed after the process of estimating precipitable water.

In the present disclosure, the mobile object 310 refers to a bus, a taxi, a train, or any other object that moves. The mobile object 310 may include a moving object other than those illustrated above. The obstacle refers to a building or any other artificial object or natural object that may, for example, reflect a GNSS signal transmitted by the GNSS satellite and adversely affect the measurement of the delay time. The obstacle may include any object other than those illustrated above that may adversely affect the measurement of the delay time.

FIG. 1 shows an example of the configuration of the water vapor measurement system 100. Referring to FIG. 1, the water vapor observation system 100 includes the GNSS satellite 200, the mobile object 310 equipped with the GNSS signal receiving apparatus 300, and the water vapor measurement apparatus 400. For example, the water vapor measurement system 100 may include one or a plurality of mobile objects 310. As shown in FIG. 1, the GNSS signal receiving apparatus 300 and the water vapor measurement apparatus 400 can connect so as to communicate with each other using wireless communication or the like. The GNSS signal receiving apparatus 300 may communicate with the water vapor measurement apparatus 400 via the mobile object 310 or the like.

The GNSS signal receiving apparatus 300 receives a GNSS signal that is a radio wave signal transmitted from the GNSS satellite 200 located in the sky over the earth. The GNSS signal receiving apparatus 300 can also acquire reception position information indicating the position of the GNSS signal receiving apparatus 300 at the time of receiving the GNSS signal, based on the received GNSS signal. For example, the GNSS signal receiving apparatus 300 may acquire the reception position information by executing a general independent positioning method or a relative positioning method.

Further, the GNSS signal receiving apparatus 300 provides the water vapor observation apparatus 400 with the GNSS signal and the reception position information. The GNSS signal receiving apparatus 300 may provide the water vapor observation apparatus 400 with the above information via the mobile object 310.

As mentioned above, the GNSS signal receiving apparatus 300 is mounted on the mobile object 310. Therefore, it can also be said that the GNSS signal receiving apparatus 300 acquires reception position information indicating the position of the mobile object 310 based on the GNSS signal. Moreover, the GNSS signal receiving apparatus 300 may be mounted at any location of the mobile object 310, such as on the roof of the mobile object 310. The GNSS signal receiving apparatus 300 may be installed at any location different from the mobile object 310, such as on the ground surface and on a building.

The water vapor observation apparatus 400 is an information processing apparatus that analyzes the GNSS signal and estimates precipitable water representing a water vapor content in the sky over a measurement point corresponding to a position where the GNSS signal has been received. Moreover, the water vapor observation apparatus 400 can determine whether or not to use the received GNSS signal for estimation of precipitable water based on the positional relation between the GNSS satellite 200 and the GNSS signal receiving apparatus 300 at the time of reception of the GNSS signal.

FIG. 2 shows an example of the configuration of the water vapor observation apparatus 400. Referring to FIG. 2, the water vapor observation apparatus 400 includes, as main components, an operation input unit 410, a screen display unit 420, a communication I/F unit 430, a storing unit 440, and an operation processing unit 450, for example.

In FIG. 2, a case of realizing a function as the water vapor observation apparatus 400 by one information processing apparatus is illustrated. However, at least part of the function as the water vapor observation apparatus 400 may be realized by a plurality of information processing apparatuses, for example, realized on the cloud. Moreover, the water vapor observation apparatus 400 may not include part of the configuration illustrated above, such as without the operation input unit 410 and the screen display unit 420, and may have a configuration other than the configuration illustrated above.

The operation input unit 410 includes an operation input device such as a keyboard and a mouse. The operation input unit 410 detects an operation by an operator who operates the water vapor observation apparatus 400 and outputs to the operation processing unit 450.

The screen display unit 420 includes a screen display device such as a liquid crystal display and an organic EL (electroluminescence) display. The screen display unit 420 can display on the screen a variety of information stored in the storing unit 440 in response to an instruction from the operation processing unit 450.

The communication I/F unit 430 includes a data communication circuit, and the like. The communication I/F unit 430 performs data communication with various sensors and other external devices connected via a communication line.

The storing unit 440 is a storage device such as a hard disk and a memory. The storing unit 440 stores processing information and a program 444 that are necessary for a variety of processing by the operation processing unit 450. The program 444 is loaded and executed by the operation processing unit 450 and thereby realizes various processing units. The program 444 is loaded in advance from an external device or a recording medium via a data input/output function such as the communication I/F unit 430, and is stored in the storing unit 440. Main information stored in the storing unit 440 includes, for example, GNSS information 441, obstacle information 442, and mobile object position information 443.

The GNSS information 441 is information indicating the position of the GNSS satellite 200. For example, the GNSS information 441 may be orbital information of the GNSS satellite 200, or the like. The GNSS information 441 is acquired in advance by any method such as inputting via the operation input unit 410 or acquiring from an external device via the communication I/F unit 430, and is stored in the storing unit 440.

The obstacle information 442 includes information on an obstacle, such as a building, that may adversely affect the measurement of the delay time. For example, the obstacle information 442 can include information indicating the position of an obstacle such as longitude and latitude, information indicating the range of an obstacle, information indicating the height of an obstacle, and any other information. The obstacle information 442 is acquired in advance by any method such as inputting via the operation input unit 410 or acquiring from an external device via the communication I/F unit 430, and is stored in the storing unit 440.

The mobile object position information 443 includes reception position information indicating the position of the mobile object 310 at the time of reception of the GNSS signal. The mobile object position information 443 is updated in response to acquisition of the reception position information by an information acquiring unit 451 to be described later.

The operation processing unit 450 includes an arithmetic logic unit such as a CPU (Central Processing Unit) and a peripheral circuit thereof. The operation processing unit 450 loads the program 444 from the storing unit 440 and executes the program 444, and thereby makes the above hardware and the program 444 cooperate and realizes various processing units. Main processing units realized by the operation processing unit 450 include, for example, the information acquiring unit 451, a satellite position acquiring unit 452, a positional relation calculating unit 453, a collision determining unit 454, an estimating unit 455, and an output unit 456.

Meanwhile, the operation processing unit 450 may include, instead of the abovementioned CPU, a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of them.

The information acquiring unit 451 acquires a GNSS signal, reception position information and the like from the GNSS signal receiving apparatus 300. The information acquiring unit 451 may acquire a GNSS signal from the GNSS signal receiving apparatus 300 and also acquire reception position information based on the acquired GNSS signal. Moreover, the information acquiring unit 451 stores the acquired reception position information as the mobile object position information 443 into the storing unit 440.

The satellite position acquiring unit 452 acquires satellite position information indicating the position of the GNSS satellite 200. For example, the satellite position acquiring unit 452 refers to the GNSS information 441, and thereby acquires the satellite position information at the time of reception of the GNSS signal by the GNSS signal receiving apparatus 300. The satellite position acquiring unit 452 may acquire the satellite information 452 based on the GNSS signal and the like.

The positional relation calculating unit 453 calculates the positional relation between the GNSS satellite 200 and the GNSS signal receiving apparatus 300 at the time of reception of the GNSS signal by the GNSS signal receiving apparatus 300, based on the reception position information and the satellite position information. For example, the positional relation calculating unit 453 calculates, as a value indicating the positional relation, a value that corresponds to the direction or orientation when the GNSS satellite 200 is viewed from the GNSS signal receiving apparatus 300. The positional relation calculating unit 453 also calculates, as a value indicating the positional relation, a value that corresponds to the distance between the GNSS signal receiving apparatus 300 and the GNSS satellite 200, the height at which the GNSS satellite 200 is located, and the like. The positional relation calculating unit 453 may calculate a value indicating a positional relation other than those illustrated above.

FIG. 3 shows an example of processing by the positional relation calculating unit 453. For example, as shown in FIG. 3, the positional relation calculating unit 453 can calculate a plane angle α corresponding to the positional relation in the two-dimensional space between the GNSS satellite 200 and the GNSS signal receiving apparatus 300, as a value indicating the positional relation between the GNSS satellite 200 and the GNSS signal receiving apparatus 300. For example, the positional relation calculating unit 453 may calculate the plane angle α in the XY coordinates as illustrated in FIG. 3 based on the reception position information and the satellite position information. Meanwhile, the positional relation calculating unit 453 may calculate the plane angle α as an angle from any set reference. The positional relation calculating unit 453 also calculates a solid angle β corresponding to the positional relation in the three-dimensional space between the GNSS satellite 200 and the GNSS signal receiving apparatus 300. For example, the positional relation calculating unit 453 may calculate the solid angle β in the XYZ coordinates as illustrated in FIG. 3 based on the reception position information and the satellite position information.

For example, the positional relation calculating unit 453 calculates both the plane angle α and the solid angle β as the values indicating the positional relation. The positional relation calculating unit 453 may calculate only part of those illustrated above, for example, only the plane angle α as the value indicating the positional relation.

The collision determining unit 454 checks whether or not an obstacle is present between the GNSS satellite 200 and the GNSS signal receiving apparatus 300 based on the value indicating the positional relation calculated by the positional relation calculating unit 453. In other words, the collision determining unit 454 checks whether or not the GNSS signal transmitted by the GNSS satellite 200 is reflected by or collides with the obstacle based on the value indicating the positional relation. For example, by referring to the obstacle information 442, the collision determining unit 454 can check whether or not an obstacle is present between the GNSS satellite 200 and the GNSS signal receiving apparatus 300. Moreover, the collision determining unit 454 determines whether or not to use the GNSS signal for estimation of precipitable water in accordance with the check result.

For example, the collision determining unit 454 checks whether or not there is a possibility of collision based on the plane angle α. As an example, the collision determining unit 454 calculates the plane angle between each of the obstacles included by the obstacle information 442 and the GNSS signal receiving apparatus 300 with reference to the obstacle information 442. At this time, the collision determining unit 454 may calculate the plane angle only for an obstacle whose position and direction from the GNSS signal receiving apparatus 300 to be a reference satisfy a predetermined condition among the obstacles included by the obstacle information 442. Moreover, the collision determining unit 454 checks whether or not there is a possibility of collision by checking whether or not an angle identical to the plane angle α is included in the calculated plane angles.

For example, referring to FIG. 4, there is no obstacle having an identical plane angle to a plane angle α1 of a GNSS satellite 200-1. Therefore, the collision determining unit 454 determines that there is no possibility of collision in the case of the plane angle α1. On the other hand, in the case illustrated in FIG. 4, there is an obstacle having an identical plane angle to a plane angle α2 of a GNSS satellite 200-2. Therefore, the collision determining unit 454 determines that there is a possibility of collision in the case of the plane angle α2.

Further, in the case of determining that there is a possibility of collision based on the plane angle α, the collision determining unit 454 checks whether or not a collision actually occurs based on the solid angle β. As an example, the collision determining unit 454 calculates the solid angle between each of the obstacles included by the obstacle information 442 and the GNSS signal receiving apparatus 300 with reference to the obstacle information 442. At this time, the collision determining unit 454 may calculate the solid angle for an obstacle that may collide among the obstacles included by the obstacle information 442. Moreover, the collision determining unit 454 compares the calculated solid angle with the solid angle β and checks whether or not collision actually occurs.

For example, referring to FIG. 5, a solid angle β2 of a GNSS satellite 200-2 is a value equal to or more than the solid angle of the obstacle that may collide. Therefore, the collision determining unit 454 determines that there will be no collision in the case of the solid angle β2. On the other hand, in the case illustrated in FIG. 5, a solid angle β3 of a GNSS satellite 200-3 is smaller than the solid angle of the obstacle that may collide. Therefore, the collision determining unit 454 determines that there will be a collision in the case of the solid angle β3.

For example, as described above, the collision determining unit 454 determines that there will be a collision in a case where an angle identical to the plane angle α is included in the plane angles calculated between the satellite and the obstacles and the solid angle β is smaller than the solid angle of an obstacle that may collide. On the other hand, in a case where an angle identical to the plane angle α is not included in the plane angles calculated between the satellite and the obstacles, or in a case where the solid angle β is equal to or more than the solid angle of an obstacle that may collide, the collision determining unit 454 determines to use the GNSS signal for estimation of precipitable water.

Further, the collision determining unit 454 determines whether or not to use the GNSS signal for estimation of precipitable water in accordance with the result of the check. For example, in the case of determining that there is a collision, the collision determining unit 454 determines not to use the GNSS signal for estimation of precipitable water. On the other hand, in the case of determining that there is no possibility of a collision, or in the case of determining that there is no collision, the collision determining unit 454 determines to use the GNSS signal for estimation of precipitable water.

The estimating unit 455 estimates precipitable water at a point where the GNSS signal receiving apparatus 300 has received the GNSS signal based on the delay time of the GNSS signal. The estimating unit 455 may estimate precipitable water by a general method such as the method described in Patent Literature 1.

Further, the estimating unit 455 can perform processing based on the result of determination by the collision determining unit 454. For example, the estimating unit 455 may be configured to, in a case where the collision determining unit 454 determines to use the GNSS signal for estimation of precipitable water, estimate precipitable water. The estimating unit 455 may be configured to, in a case where the collision determining unit 454 determines to use the GNSS signal for estimation of precipitable water, discard the estimated precipitable water.

The output unit 456 outputs the result of estimation by the estimating unit 455. For example, the output unit 456 displays the result of estimation by the estimating unit 455 on the screen display unit 420, or transmit the result to an external device via the communication I/F unit 430. The output unit 456 may output the value indicating the positional relation, the result of determination by the collision determining unit 454, and so forth, in addition to the result of estimation by the estimating unit 455.

The above is an example of the configuration of the water vapor observation apparatus 400. Subsequently, an example of the operation of the water vapor observation apparatus 400 will be described with reference to FIG. 6.

FIG. 6 shows an example of the operation of the water vapor observation apparatus 400. Referring to FIG. 6, the information acquiring unit 451 acquires a GNSS signal, reception position information, and so forth, from the GNSS signal receiving apparatus 300 (step S101). The information acquiring unit 451 may acquire a GNSS signal from the GNSS signal receiving apparatus 300 and acquire reception position information based on the acquired GNSS signal.

The satellite position acquiring unit 452 acquires satellite position information indicating the position of the GNSS satellite 200 (step S102). For example, the satellite position acquiring unit 452 acquires satellite position information at the time of reception of the GNSS signal by the GNSS signal receiving apparatus 300 with reference to the GNSS information 441.

The positional relation calculating unit 453 calculates the positional relation between the GNSS satellite 200 and the GNSS signal receiving apparatus 300 at the time of reception of the GNSS signal by the GNSS signal receiving apparatus 300, based on the reception position information and the satellite position information (step S103). For example, the positional relation calculating unit 453 can calculate the plane angle α and the solid angle β as the values indicating the positional relation.

The collision determining unit 454 checks whether or not an obstacle is present between the GNSS satellite 200 and the GNSS signal receiving apparatus 300, based on the values indicating the positional relation calculated by the positional relation calculating unit 453. In other words, the collision determining unit 454 checks whether or not the GNSS signal transmitted by the GNSS satellite 200 is reflected by or collides with the obstacle, based on the values indicating the positional relation (step S104).

In a case where the GNSS signal does not collide (No at step S104), the collision determining unit 454 determines to use the GNSS signal for estimation of precipitable water (step S105). On the other hand, in a case where the GNSS signal collides (Yes, at step S104), the collision determining unit 454 determines not to use the GNSS signal for estimation of precipitable water (step S106).

The above is an example of the operation of the water vapor observation apparatus 400.

As described above, the water vapor observation system 100 includes, for example, a plurality of mobile objects 310 each equipped with the GNSS signal receiving apparatus 300. According to such a configuration, the water vapor observation system 100 can receive GNSS signals at more locations. As a result, it is possible to efficiently increase measurement points, and it is possible to estimate a water vapor content with more accuracy.

Further, the water vapor observation apparatus 400 includes the positional relation calculating unit 453 and the collision determining unit 454. With such a configuration, the collision determining unit 454 can determine whether or not to use a GNSS signal for estimation of precipitable water by checking the presence or absence of a collision based on a value indicating a positional relation calculated by the positional relation calculating unit 453. As a result, the water vapor observation apparatus 400 can be configured not to use a GNSS signal received in a case where an obstacle is present for the estimation. Consequently, it is possible to estimate a water vapor content with more accuracy while efficiently increasing measurement points.

The configuration of the water vapor observation apparatus 400 is not limited to the case illustrated in FIG. 2. For example, FIG. 7 shows another example of the configuration of the water vapor observation apparatus 400. For example, referring to FIG. 7, the storing unit 440 can store, in addition to the information illustrated in FIG. 2, information for discrimination 445, past information 446, and so forth.

The information for discrimination 445 is information used at the time of discriminating whether or not to calculate the positional relation and checking the presence or absence of a collision. For example, the information for discrimination 445 can indicate whether or not there is a need for calculating the position relation and checking the presence or absence of a collision, for each road or other predetermined area. The information for discrimination 445 may indicate the need for the check for each road on road information such as a map. Meanwhile, the information for discrimination 445 may indicate, in addition to the need for the check, whether or not to use the acquired GNSS signal for the estimation. For example, the information for discrimination 445 is acquired in advance by any method such as inputting via the operation input unit 410 or acquiring from an external device via the communication I/F unit 430, and is stored in the storing unit 440.

For example, there is little need to recheck the presence or absence of a collision on a road or area where it has already been checked that no obstacle is present in the vicinity. Therefore, the information for discrimination 445 can indicate that there is no need to check on the road or area where it has already been checked that no obstacle is present in the vicinity. Moreover, the information for discrimination 445 can indicate that there is no need to check on a road or area where there is a high possibility of collision, such as where there are many tall buildings nearby. For example, as described above, the information for discrimination 445 can indicate information corresponding to the surrounding situation and the like.

The past information 446 indicates a past determination result by the collision determining unit 454. For example, in the past information 446, the reception position information, the satellite position information, and the past determination result by the collision determining unit 454 are associated. In addition to the above, the past information 446 may include information indicating the date and time of determination by the collision determining unit 454. For example, the past information 446 is updated according to determination by the collision determining unit 454.

Further, the operation processing unit 450 can realize, in addition to the configuration illustrated in FIG. 2, a discriminating unit 457 by loading the program 444 from the storing unit 440 and executing the program 444.

The discriminating unit 457 discriminates whether or not to perform processing by the positional relation calculating unit 453 and the collision determining unit 454. For example, the discriminating unit 457 performs the above discrimination in response to acquisition of the GNSS signal and the reception position information by the information acquisition unit 451.

For example, the discriminating unit 457 checks the need for check at a position indicated by the reception position information with reference to the information for discrimination 445. Then, in a case where the check is needed, the discriminating unit 457 instructs the positional relation calculating unit 453 and the collision determining unit 454 to calculate and determine the positional relation. On the other hand, in a case where the check is not needed, the discriminating unit 457 does not issue the above instruction. In this case, the discriminating unit 457 may be configured to instruct the estimating unit 455 based on the information for discrimination 445 whether or not to estimate precipitable water.

Further, the discriminating unit 457 may discriminate whether or not to perform the processing by the positional relation calculating unit 453 and the collision determining unit 454 based on the past information 446. For example, in a case where the mobile object 310 is public transportation such as a bus, it is assumed that the mobile object 310 follows a generally fixed route, and there is a high possibility that there was a similar situation in the past. Therefore, the discriminating unit 457 refers to the past information 446 and checks whether a determination based on the same reception position information and satellite position information was made in the past. In a case where a determination based on the same reception position information and satellite position information was made in the past, the discriminating unit 457 employs the past determination result without performing new processing by the positional relation calculating unit 453 and collision determining unit 454. For example, as described above, the discriminating unit 457 may discriminate whether or not to perform the processing by the positional relation calculating unit 453 and the collision determining unit 454 after referring to the past information. Meanwhile, the discriminating unit 457 may perform the above discrimination regardless of the type of the mobile object 310, or may perform the above discrimination in a case where the type of the mobile object 310 is a predetermined type such as a bus. Information such as the type of the mobile object 310 may be acquired together with the GNSS signal by the information acquiring unit 451 from the GNSS signal receiving apparatus 300 or the like.

### Second Example Embodiment

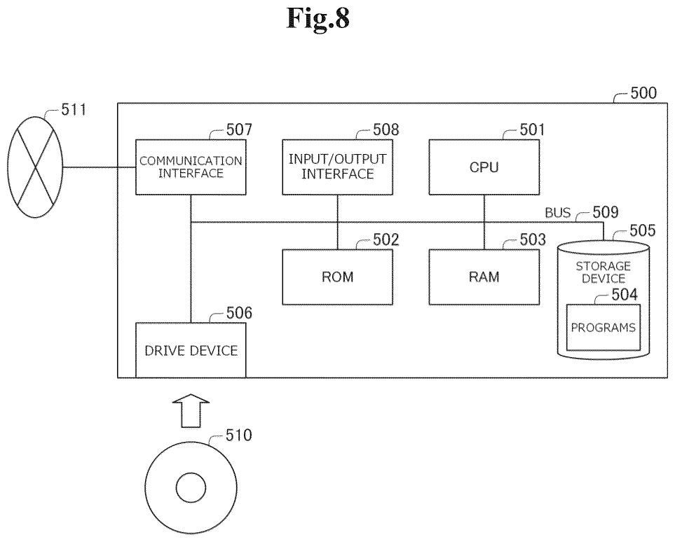

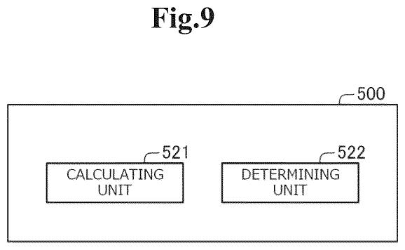

Next, a second example embodiment of the present disclosure will be described with reference to FIGS. 8 and 9. FIG. 8 is a view showing an example of the hardware configuration of a water vapor observation apparatus 500. FIG. 9 is a block diagram showing an example of the configuration of the water vapor observation apparatus 500.

In the second example embodiment of the present disclosure, the water vapor observation apparatus 500 that estimates precipitable water representing a water vapor content in the atmosphere based on a GNSS signal will be described. FIG. 8 shows an example of the hardware configuration of the water vapor observation apparatus 500. Referring to FIG. 8, the water vapor observation apparatus 500 has, as an example, the following hardware configuration including;
a CPU (Central Processing Unit) 501 (arithmetic logic unit),
a ROM (Read Only Memory) 502 (memory unit),
a RAM (Random Access Memory) 503 (memory unit),
programs 504 loaded to the RAM 503,
a storage device 505 that stores the programs 504,
a drive device 506 that performs reading from and writing into a recording medium 510 outside an information processing apparatus,
a communication interface 507 that connects with a communication network 511 outside the information processing apparatus,
an input/output interface that performs input/output of data, and
a bus 509 that connects the respective components.

Further, the water vapor observation apparatus 500 can realize functions as a determining unit 521 and an estimating unit 522 shown in FIG. 9 by acquisition and execution of the programs 504 by the CPU 501. The programs 504 are, for example, stored in the storage device 505 and the ROM 502 in advance and loaded to the RAM 503 and executed by the CPU 501 as necessary. Also, the programs 504 may be supplied to the CPU 501 via the communication network 511, or may be stored in the recording medium 510 in advance and read out by the drive device 506 and supplied to the CPU 501.

FIG. 8 shows an example of the hardware configuration of the water vapor observation apparatus 500. The hardware configuration of the water vapor observation apparatus 500 is not limited to the abovementioned case. For example, the water vapor observation apparatus 500 may be configured with part of the abovementioned configuration, such as without the drive device 506. Moreover, the CPU 501 may be a GPU illustrated in the first example embodiment, for example.

The determining unit 521 determines according to a positional relation between a receiving apparatus mounted on a mobile object and a GNSS satellite transmitting a GNSS signal whether or not to use the GNSS signal received by the receiving apparatus for estimation of precipitable water. For example, the determining unit 521 determines whether or not to use the GNSS signal received by the receiving apparatus for estimation of precipitable water, according to a positional relation between the receiving apparatus and the GNSS satellite.

The estimating unit 522 estimates precipitable water representing a water vapor content in the atmosphere based on the GNSS signal received by the receiving apparatus, based on the result of determination by the determining unit 521. Alternatively, the estimating unit 522 discards the estimated precipitable water based on the result of determination by the determining unit 521.

Thus, the water vapor observation apparatus 500 has the determining unit 521 and the estimating unit 522. With such a configuration, the estimating unit 522 can estimate precipitable water representing a water vapor content in the atmosphere based on a GNSS signal received by the receiving apparatus in accordance with the result of determination by the determining unit 521. As a result, it is possible to estimate precipitable water, for example, when the positional relation is appropriate, and it is possible to more accurately estimate precipitable water even when the receiving apparatus is mounted on a mobile object.

The water vapor observation apparatus 500 described above can be realized by installation of a predetermined program into an information processing apparatus such as the water vapor observation apparatus 500. Specifically, a program as another aspect of the present invention is a program for causing an information processing apparatus such as the water vapor observation apparatus 500 to realize processes to: in accordance with a positional relation between a receiving apparatus that is mounted on a mobile object and receives a GNSS (Global Navigation Satellite System) signal and a GNSS satellite that transmits the GNSS signal when the receiving apparatus receives the GNSS signal, determine whether or not to use the GNSS signal received by the receiving apparatus for estimation of precipitable water; and, in accordance with a result of the determination, estimate precipitable water representing a water vapor content in the atmosphere based on the GNSS signal received by the receiving apparatus or discard the estimated precipitable water.

Further, a water vapor observation method executed by an information processing apparatus such as the water vapor observation apparatus 500 described above is a method including: in accordance with a positional relation between a receiving apparatus that is mounted on a mobile object and receives a GNSS (Global Navigation Satellite System) signal and a GNSS satellite that transmits the GNSS signal when the receiving apparatus receives the GNSS signal, determining whether or not to use the GNSS signal received by the receiving apparatus for estimation of precipitable water; and, in accordance with a result of the determination, estimating precipitable water representing a water vapor content in the atmosphere based on the GNSS signal received by the receiving apparatus or discarding the estimated precipitable water.

The inventions of a program, a computer-readable recording medium on which a program is recorded, and a water vapor observation method with the abovementioned configurations can also achieve the object of the present disclosure mentioned above because they exert the same actions and effects as the above water vapor observation apparatus 500.

### Supplementary Notes

The whole or part of the example embodiments disclosed above can be described as the following supplementary notes. Below, the overview of the configurations of a water vapor observation method, a water vapor observation apparatus, and a program according to the present invention will be described. However, the present invention is not limited to the following configurations.

### Supplementary Note 1

A water vapor observation method by an information processing apparatus, the method comprising:
determining whether or not to use a GNSS (Global Navigation Satellite System) signal received by a receiving apparatus for estimation of precipitable water in accordance with a positional relation between the receiving apparatus and a GNSS satellite at time of reception of the GNSS signal by the receiving apparatus, the receiving apparatus being mounted on a mobile object and receiving the GNSS signal, the GNSS satellite transmitting the GNSS signal; and
estimating precipitable water representing a water vapor content in atmosphere based on the GNSS signal received by the receiving apparatus or discarding the estimated precipitable water in accordance with a result of the determining.

### Supplementary Note 2

The water vapor observation method according to Supplementary Note 1, comprising:
checking whether or not a predetermined obstacle is present between the receiving apparatus and the GNSS satellite based on reception position information indicating a position of reception of the GNSS signal by the receiving apparatus and satellite position information indicating a position of the GNSS satellite; and
determining whether or not to use the GNSS signal received by the receiving apparatus for estimation of precipitable water in accordance with a result of the checking.

### Supplementary Note 3

The water vapor observation method according to Supplementary Note 2, comprising:
calculating a value indicating the positional relation between the receiving apparatus and the GNSS satellite based on the reception position information and the satellite position information; and
checking whether or not the obstacle is present between the receiving apparatus and the GNSS satellite based on the calculated value and information on the obstacle stored in advance.

### Supplementary Note 4

The water vapor observation method according to Supplementary Note 3, comprising
calculating, as the value indicating the positional relation, a plane angle corresponding to a positional relation on two-dimensional space between the receiving apparatus and the GNSS satellite.

### Supplementary Note 5

The water vapor observation method according to Supplementary Note 4, comprising
calculating, as the value indicating the positional relation, a solid angle corresponding to a positional relation on three-dimensional space between the receiving apparatus and the GNSS satellite.

### Supplementary Note 6

The water vapor observation method according to Supplementary Note 5, comprising
determining that the obstacle is present between the receiving apparatus and the GNSS satellite in a case where a plane angle calculated between the obstacle and the receiving apparatus includes an angle identical to the plane angle corresponding to the positional relation on two-dimensional space between the receiving apparatus and the GNSS satellite, and the calculated solid angle is smaller than a solid angle between the obstacle that may cause collision and the receiving apparatus.

### Supplementary Note 7

The water vapor observation method according to any one of Supplementary Notes 2 to 6, comprising:
discriminating whether or not to check presence or absence of the obstacle based on information indicating a surrounding situation stored in advance; and
checking whether or not the predetermined obstacle is present between the receiving apparatus and the GNSS satellite in accordance with a result of the discriminating.

### Supplementary Note 8

The water vapor observation method according to any one of Supplementary Notes 2 to 7, comprising:
discriminating whether or not to check presence or absence of the obstacle based on information indicating a past checking result; and
checking whether or not the predetermined obstacle is present between the receiving apparatus and the GNSS satellite in accordance with a result of the discriminating.

### Supplementary Note 9

A water vapor observation apparatus comprising:
a determining unit that determines whether or not to use a GNSS (Global Navigation Satellite System) signal received by a receiving apparatus for estimation of precipitable water in accordance with a positional relation between the receiving apparatus and a GNSS satellite at time of reception of the GNSS signal by the receiving apparatus, the receiving apparatus being mounted on a mobile object and receiving the GNSS signal, the GNSS satellite transmitting the GNSS signal; and
an estimating unit that estimates precipitable water representing a water vapor content in atmosphere based on the GNSS signal received by the receiving apparatus or discards the estimated precipitable water in accordance with a result of the determining.

### Supplementary Note 10

A computer program comprising instructions for causing an information processing apparatus to realize processes to:
determine whether or not to use a GNSS (Global Navigation Satellite System) signal received by a receiving apparatus for estimation of precipitable water in accordance with a positional relation between the receiving apparatus and a GNSS satellite at time of reception of the GNSS signal by the receiving apparatus, the receiving apparatus being mounted on a mobile object and receiving the GNSS signal, the GNSS satellite transmitting the GNSS signal; and
estimate precipitable water representing a water vapor content in atmosphere based on the GNSS signal received by the receiving apparatus or discard the estimated precipitable water in accordance with a result of the determining.

The program described in the example embodiments and supplementary notes is stored in a storage device, or recorded on a computer-readable recording medium. For example, the recording medium is a portable medium such as a flexible disk, an optical disk, a magneto-optical disk, and a semiconductor memory.

Although the present invention has been described above with reference to the example embodiments, the present invention is not limited to the above example embodiments. The configurations and details of the present invention can be changed in various manners that can be understood by one skilled in the art within the scope of the present invention.

### DESCRIPTION OF REFERENCE NUMERALS

100 water vapor observation system
200 GNSS satellite
300 GNSS signal receiving apparatus
310 mobile object
400 water vapor observation apparatus
410 operation input unit
420 screen display unit
430 communication I/F unit
440 storing unit
441 GNSS information
442 obstacle information
443 mobile object position information
444 program
445 information for discrimination
446 past information
450 operation processing unit
451 information acquiring unit
452 satellite position acquiring unit
453 positional relation calculating unit
454 collide determining unit
455 estimating unit
456 output unit
457 discriminating unit
500 water vapor observation apparatus
501 CPU
502 ROM
503 RAM
504 programs
505 storage device
506 drive device
507 communication interface
508 input/output interface
509 bus
510 recoding medium
511 communication network
521 determining unit
522 estimating unit

1. A water vapor observation method by an information processing apparatus, the method comprising:
determining whether or not to use a GNSS (Global Navigation Satellite System) signal received by a receiving apparatus for estimation of precipitable water in accordance with a positional relation between the receiving apparatus and a GNSS satellite at time of reception of the GNSS signal by the receiving apparatus, the receiving apparatus being mounted on a mobile object and receiving the GNSS signal, the GNSS satellite transmitting the GNSS signal; and
estimating precipitable water representing a water vapor content in atmosphere based on the GNSS signal received by the receiving apparatus or discarding the estimated precipitable water in accordance with a result of the determining.

2. The water vapor observation method according to claim 1, comprising:
checking whether or not a predetermined obstacle is present between the receiving apparatus and the GNSS satellite based on reception position information indicating a position of reception of the GNSS signal by the receiving apparatus and satellite position information indicating a position of the GNSS satellite; and
determining whether or not to use the GNSS signal received by the receiving apparatus for estimation of precipitable water in accordance with a result of the checking.

3. The water vapor observation method according to claim 2, comprising:
calculating a value indicating the positional relation between the receiving apparatus and the GNSS satellite based on the reception position information and the satellite position information; and
checking whether or not the obstacle is present between the receiving apparatus and the GNSS satellite based on the calculated value and information on the obstacle stored in advance.

4. The water vapor observation method according to claim 3, comprising
calculating, as the value indicating the positional relation, a plane angle corresponding to a positional relation on two-dimensional space between the receiving apparatus and the GNSS satellite.

5. The water vapor observation method according to claim 4, comprising
calculating, as the value indicating the positional relation, a solid angle corresponding to a positional relation on three-dimensional space between the receiving apparatus and the GNSS satellite.

6. The water vapor observation method according to claim 5, comprising
determining that the obstacle is present between the receiving apparatus and the GNSS satellite in a case where a plane angle calculated between the obstacle and the receiving apparatus includes an angle identical to the plane angle corresponding to the positional relation on two-dimensional space between the receiving apparatus and the GNSS satellite, and the calculated solid angle is smaller than a solid angle between the obstacle that may cause collision and the receiving apparatus.

7. The water vapor observation method according to claim 2, comprising:
discriminating whether or not to check presence or absence of the obstacle based on information indicating a surrounding situation stored in advance; and
checking whether or not the predetermined obstacle is present between the receiving apparatus and the GNSS satellite in accordance with a result of the discriminating.

8. The water vapor observation method according to claim 2, comprising:
discriminating whether or not to check presence or absence of the obstacle based on information indicating a past checking result; and
checking whether or not the predetermined obstacle is present between the receiving apparatus and the GNSS satellite in accordance with a result of the discriminating.

9. A water vapor observation apparatus comprising:
at least one memory storing processing instructions; and
at least one processor configured to execute the processing instructions to:
determine whether or not to use a GNSS (Global Navigation Satellite System) signal received by a receiving apparatus for estimation of precipitable water in accordance with a positional relation between the receiving apparatus and a GNSS satellite at time of reception of the GNSS signal by the receiving apparatus, the receiving apparatus being mounted on a mobile object and receiving the GNSS signal, the GNSS satellite transmitting the GNSS signal; and
estimate precipitable water representing a water vapor content in atmosphere based on the GNSS signal received by the receiving apparatus or discard the estimated precipitable water in accordance with a result of the determining.

10. A non-transitory computer-readable recording medium on which a computer program is recorded, the program comprising instructions for causing an information processing apparatus to realize processes to:
determine whether or not to use a GNSS (Global Navigation Satellite System) signal received by a receiving apparatus for estimation of precipitable water in accordance with a positional relation between the receiving apparatus and a GNSS satellite at time of reception of the GNSS signal by the receiving apparatus, the receiving apparatus being mounted on a mobile object and receiving the GNSS signal, the GNSS satellite transmitting the GNSS signal; and
estimate precipitable water representing a water vapor content in atmosphere based on the GNSS signal received by the receiving apparatus or discard the estimated precipitable water in accordance with a result of the determining.
